(19) United States
(12) Patent Application Publication
(10) Pub. No.: US 2004/0144581 A1
(43) Pub. Date: Jul. 29, 2004

(54) Suspension system powered supercharger

(76) Inventor: William Harvey Bratton, Las Vegas, NV (US)

Correspondence Address: WILLIAM BRATTON, 8209 BRITTANY HARBOR, LAS VEGAS, NV, 89128, US

(21) Appl. No.: 10/348,886

(22) Filed: Jan. 23, 2003

(51) Int. Cl. B60K 25/10

(52) U.S. Cl. 180/165

(57) ABSTRACT

A suspension system operated supercharger for supercharging the internal combustion engine powering a sprung vehicle includes a method of capturing the kinetic energy of the suspension system of said vehicle as the vehicle traverses uneven terrain, and using that energy to power the supercharger. In a preferred embodiment, a hydraulic pump attached operably to the suspension system operates a hydraulic turbine. The hydraulic turbine has a common shaft with an air compressor. The air compressor draws air from the environment, compresses it and sends it to the engine where fuel is burned more efficiently in the increased air available to the engine. The engine uses less fuel without sacrificing engine power.

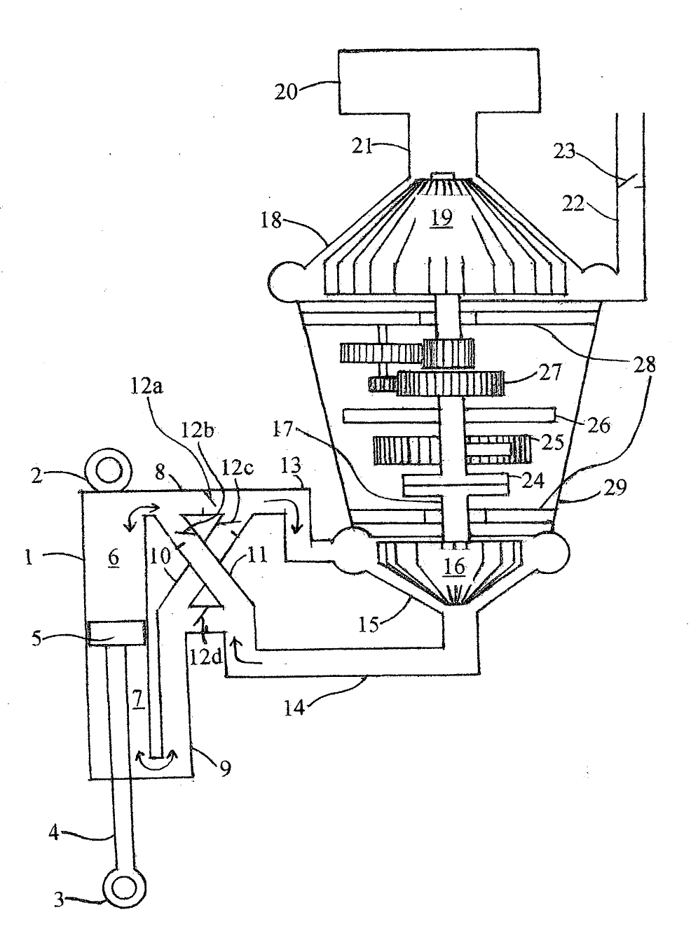

### CROSS-REFERENCE TO RELATED APPLICATIONS

Not Applicable

### STATEMENT REGARDING FEDERALLY SPONSORED RESEARCH AND DEVELOPMENT

Not Applicable

### BACKGROUND OF THE INVENTION

1. Field of the Invention

The present invention discloses a supercharger for an internal combustion engine in a sprung vehicle. The supercharger is operated by the motion of the vehicle's suspension system as the vehicle moves over uneven terrain, and is used to reduce fuel consumption without sacrificing engine power.

2. Description of Related Art

An internal combustion engine gets the air needed to drive the engine from the negative pressure generated when the engine is driven. To more efficiently burn the fuel in the engine, more air should be provided to the engine.

A review of the prior art discloses three types of devices which force air under pressure into the engine. The turbocharger uses the engine's exhaust gases to drive a gas turbine which in turn operates an air compressor. The supercharger is an air compressor which is driven mechanically by the engine. The art of both devices is well known.

U.S. Pat. Nos. 1,840,253, 4,485,310, 5,638,796, 6,135,098, and 6,328,024 disclose the third type of device, namely an air compressor driven by an electric motor. The electric motor is operated by the engine that is being supercharged.

All three devices are operated directly or indirectly by the engine they empower. All three increase the power of the engine but also increase the amount of fuel the engine consumes.

The present invention is operated by a power source other than the engine, namely the vehicle's suspension system, and is used to burn fuel more efficiently, thereby decreasing fuel consumption without sacrificing engine power.

### SUMMARY OF THE INVENTION

The present invention discloses a method of powering a supercharger for the internal combustion engine of a sprung vehicle by harnessing the kinetic energy of the said sprung vehicle's suspension system as the vehicle traverses uneven terrain. This method of supercharging an engine lets the engine maintain a constant power output while burning less fuel more efficiently when the supercharger is operating, and without having to surrender energy to operate the supercharger. The results would be reduced fuel consumption.

A thorough search of the prior art was conducted, and no device similar to the present invention was found. No supercharging system was found which is operated by a sprung vehicle's suspension system. Likewise, no suspension system of a sprung vehicle was found which is used to drive a supercharger to reduce fuel consumption in an internal combustion engine

### BRIEF DESCRIPTION OF THE DRAWING

The drawing is a schematic diagram of a preferred embodiment of the present invention to illustrate, without limiting the scope of the invention, how the present invention can be used to supercharge an internal combustion engine.

### DETAILED DESCRIPTION OF THE INVENTION

The present invention is intended for use in a sprung vehicle powered by an internal combustion engine. The purpose of the invention is to harness the kinetic energy produced by a sprung vehicle's suspension system as the vehicle moves over uneven terrain, and use this energy to operate a supercharger to more efficiently burn fuel. The following detailed description of a preferred embodiment of the present invention should not be construed as in any way limiting the scope of the invention, but is used here to demonstrate how one embodiment of the present invention uses the energy of the suspension system to supercharge an internal combustion engine.

In the schematic drawing, 1 represents the cylindrical housing of a hydraulic pump. Rings 2 and 3 represents points of attachment of the hydraulic pump to the sprung vehicle. Ring 2 on the hydraulic pump housing attaches to one of either the body/frame/chassis of the vehicle or the axle assembly/lower control arm of the vehicle, and ring 3 on piston rod 4 attaches to the other of the body/frame/chassis or the axle assembly/lower control arm.

As is normal in a sprung vehicle traversing uneven terrain, the axle assembly/lower control arm moves toward or away from the body/frame/chassis within the limits of the vehicle's springs. In a vehicle using the present invention this motion would cause piston 5, which is attached to piston rod 4, to move back and forth inside hydraulic pump housing 1.

Chambers 6 and 7 are hydraulic fluid filled cavities within hydraulic pump housing 1. Piston 5 is sealed in such a way that hydraulic fluid cannot pass between chambers 6 and 7 past the piston. Likewise piston rod 4 is sealed in such a way that fluid cannot pass between it and the port in the end of hydraulic housing 1 and thereby escape from chamber 7. Hydraulic hoses 8 and 9 are fixed to and open into chambers 6 and 7 respectively. The only way hydraulic fluid can enter or leave chammber 6 is through hydraulic hose 8; likewise, the only way hydraulic fluid can enter or leave chamber 7 is through hydraulic hose 9.

When the motion of piston 5 compresses the hydraulic fluid in chamber 6, the fluid passes through a series of hydraulic fluid channels as described below and enters into chamber 7; likewise, when the opposite motion of piston 5 compresses the fluid in chamber 7, the fluid is forced back into chamber 6.

Hydraulic fluid can pass in either direction in high pressure hydraulic hoses 8 and 9, as represented by arrows.

Cross connections 10 and 11 are high pressure hydraulic fluid channnels connecting hydraulic hoses 8 and 9.

12a, 12b, 12c, and 12d are check valves in the hydraulic hoses as illustrated to insure that fluid entering high pressure hydraulic hose 13 always travels away from the hydraulic pump housing 1 and towards the hydraulic turbine housing 15; likewise, the check valves insure that fluid entering hydraulic hose 14 always travels away from the hydraulic turbine housing 15 and towards the hydraulic pump housing 1.

Hydraulic fluid pumped through hydraulic hose 13 enters hydraulic turbine housing 15 under pressure. The fluid turns hydraulic turbine blades 16 and then exits the turbine housing through hydraulic hose 14 to return to the hydraulic pump.

Hydraulic turbine blades 16 are operably attached to shaft 17. Shaft 17 passes out of hydraulic turbine housing 15 and into air compressor housing 18. At this end of shaft 17 are operably attached air impellor blades 19. When impellor blades 19 are rotated by shaft 17, air is drawn through air filter 20 into air hose 21 and then into air compressor housing 18. There the air is compressed and sent to air hose 22 and on to the vehicle's internal combustion engine (not shown). Pressure sensors (not shown) in the engine monitor the increased air flow to the engine's intake manifold and adjusts the air/fuel mixture to conserve fuel. Check valve 23 in air hose 22 prevents backflow from the engine to the supercharger.

24 represents a clutch or comparable device which protects the components of the present invention from severe suspension system shock.

25 represents a pawl-and-rachet or comparable device to insure that shaft 17 rotates only in the desired direction.

26 represents a flywheel or comparable device to insure that rotation, once achieved, is maintained at the highest possible rpm.

27 represents a gear chain, planetary gear, or comparable device to insure that the rpm of shaft 17 is increased optimally between the hydraulic turbine and the air compressor.

28 represents shaft 17 bearings.

29 represents shaft 17 housing.

assembly/lower control arm of the vehicle, and ring 3 on piston rod 4 attaches to the other of the body/frame/chassis or the axle assembly/lower control arm.

As is normal in a sprung vehicle traversing uneven terrain, the axle assembly/lower control arm moves toward or away from the body/frame/chassis within the limits of the vehicle's springs. In a vehicle using the present invention this motion would cause piston 5, which is attached to piston rod 4, to move back and forth inside hydraulic pump housing 1.

Chambers 6 and 7 are hydraulic fluid filled cavities within hydraulic pump housing 1. Piston 5 is sealed in such a way that hydraulic fluid cannot pass between chambers 6 and 7 past the piston. Likewise piston rod 4 is sealed in such a way that fluid cannot pass between it and the port in the end of hydraulic housing 1 and thereby escape from chamber 7. Hydraulic hoses 8 and 9 are fixed to and open into chambers 6 and 7 respectively. The only way hydraulic fluid can enter or leave chammber 6 is through hydraulic hose 8; likewise, the only way hydraulic fluid can enter or leave chamber 7 is through hydraulic hose 9.

When the motion of piston 5 compresses the hydraulic fluid in chamber 6, the fluid passes through a series of hydraulic fluid channels as described below and enters into chamber 7; likewise, when the opposite motion of piston 5 compresses the fluid in chamber 7, the fluid is forced back into chamber 6.

Hydraulic fluid can pass in either direction in high pressure hydraulic hoses 8 and 9, as represented by arrows.

Cross connections 10 and 11 are high pressure hydraulic fluid channnels connecting hydraulic hoses 8 and 9.

12a, 12b, 12c, and 12d are check valves in the hydraulic hoses as illustrated to insure that fluid entering high pressure hydraulic hose 13 always travels away from the hydraulic pump housing land towards the hydraulic turbine housing 15; likewise, the check valves insure that fluid entering hydraulic hose 14 always travels away from the hydraulic turbine housing 15 and towards the hydraulic pump housing 1.

Hydraulic fluid pumped through hydraulic hose 13 enters hydraulic turbine housing 15 under pressure. The fluid turns hydraulic turbine blades 16 and then exits the turbine housing through hydraulic hose 14 to return to the hydraulic pump.

Hydraulic turbine blades 16 are operably attached to shaft 17. Shaft 17 passes out of hydraulic turbine housing 15 and into air compressor housing 18. At this end of shaft 17 are operably attached air impellor blades 19. When impellor blades 19 are rotated by shaft 17, air is drawn through air filter 20 into air hose 21 and then into air compressor housing 18. There the air is compressed and sent to air hose 22 and on to the vehicle's internal combustion engine (not shown). Pressure sensors (not shown) in the engine monitor the increased air flow to the engine's intake manifold and adjusts the air/fuel mixture to conserve fuel. Check valve 23 in air hose 22 prevents backflow from the engine to the supercharger.

24 represents a clutch or comparable device which protects the components of the present invention from severe suspension system shock.

25 represents a pawl-and-rachet or comparable device to insure that shaft 17 rotates only in the desired direction.

26 represents a flywheel or comparable device to insure that rotation, once achieved, is maintained at the highest possible rpm.

27 represents a gear chain, planetary gear, or comparable device to insure that the rpm of shaft 17 is increased optimally between the hydraulic turbine and the air compressor.

28 represents shaft 17 bearings.

29 represents shaft 17 housing.

What is claimed is:

1. An invention for supercharging the internal combustion engine powering a sprung vehicle to more efficiently burn fuel by using the kinetic energy of the said vehicle's suspension system as the vehicle traverses uneven terrain.

2. A preferred embodiment of the present invention comprises:
a sprung, internal combustion engine-powered vehicle with a hydraulic pump, the said pump's housing attached to one or the other of the said sprung vehicle's body/fram/chassis or the said vehicle's axle assembly/lower control arm;
the said hydraulic pump's piston rod connected to the other of the said sprung vehicle's body/frame/chassis or the said vehicle's axle assembly/lower control arm;
the motion of the vehicle's suspension as the vehicle moves over uneven terrain operates the hydraulic pump which forces hydraulic fluid through a series of high pressure hydraulic channels and check valves to operate a hydraulic turbine;
the said hydraulic turbine shares a common shaft with, and thereby operates, an air compressor;
the said air compressor drawa air from the environment and forces it under pressure into the internal combustion engine, where sensors detecting the increased air pressure reduce the flow of fuel, the increased air pressure allowing less fuel to be burned more efficiently, thus maintaining the engine's power output at a desired rate while reducing fuel consumption.

3. Other embodiments of the present invention comprise cables, springs, gears, chain-and-sprockets, pawl-and-ratchets, or other devices or combinations of these or other devices, all of which serve the same essential function of harnessing the vehicle's suspension system's kinetic energy to operate a supercharger, and the use of these devices should in no way limit the scope of the present invention.
